(19) United States
(12) Patent Application Publication
(10) Pub. No.: US 2018/0329874 A1
(43) Pub. Date: Nov. 15, 2018

(54) COMPUTER SYSTEM AND METHOD FOR AUTOMATEDLY WRITING A USER'S AUTOBIOGRAPHY

(71) Applicant: Zena Peden, Surry (CA)

(72) Inventor: Zena Peden, Surry (CA)

(21) Appl. No.: 16/029,568

(22) Filed: Jul. 7, 2018

Related U.S. Application Data
(63) Continuation-in-part of application No. 14/296,839, filed on Jun. 5, 2014.

(51) Int. Cl. G06F 17/24

(52) U.S. Cl. CPC G06F 17/24

(57) ABSTRACT

Computer systems and methods for enabling a user of an electronic computing device, such as a smartphone, tablet, etc., to create a digital autobiographical book by merely verbally answering computer generated questions. Questions may cover areas pertaining to the user's family, career, childhood, etc. When the user responds to a question, the computer analyzes the words and phrases within the user's statement to identify keywords, central topics and themes, dates and events, etc. that the computer uses to classify and group information. The information is then used by the computer to determine if any follow-up questions are needed to clarify the user's answer. The computer then compiles the information, which may also include other digital media, such as digital pictures, videos, etc. maps out the user's life chronologically, by event and topic, filters and analyzes the information, and subsequently and automatedly writes, edits and publishes a digital book.

### CROSS-REFERENCES TO RELATED APPLICATIONS

The Application is a Continuation-in-part to application Ser. No. 14/296,839 filed on Jun. 5, 2014.

### BACKGROUND OF THE INVENTION

### 1. Field of Invention

The present disclosure is generally related to a network based service and/or a mobile app for automatedly generating a user's autobiographical book in response to the user's answers to machine generated questions.

### 2. Description of Related Art

In today's market of rapidly evolving social media comprising for example, tweets, blogs, Facebook® posts, viewers of the media are enticed into disclosing online their own opinions, current activities, personal history, etc. As a result, an industry for self-publishing online digital book has flourished in recent years.

In addition to producing an e-book for family and friends, some authors are motivated to self-publish eBooks for a variety of less obvious reasons. Traditional publishing companies now search for new manuscripts by looking at reader comments about self-published books sold online. Therefore, new authors are using self-publishing to break into the market and find a literary agent who is willing to represent them. Additionally, professionals are using self-publishing as a form of an enhanced business card, such as an enhanced resume providing an example of a person's work be it scientific, creative, etc. and in the form of an article, short story, and or a complete digital book divided into chapters.

An author today can self-publish for a nominal fee within an hour by uploading a manuscript or collection of photos to an online publishing platform. Many books will appear for sale on websites such Amazon®; while others are sold through the self-publishing companies' websites. Authors and readers can then order subsequent copies as needed.

Unfortunately these self-publishing services still require the user to write and edit the manuscript, article, short story, etc. Many authors, though, do not have the time, or writing skills to do this. Therefore, there is a need within the self-publishing industry for a computerized, online platform that does this for the user by, for example, having the user verbally input subject matter that the computer then re-organizes, writes, and publishes into the required format e.g. an eBook.

### SUMMARY OF THE INVENTION

The various embodiments of the present disclosure are directed to computer systems, methods, apparatuses, and non-transitory media for enabling a user of an electronic computing device, such as a smartphone, tablet, laptop, etc., to create a textual document, such as a biographical or autobiographical book, short story, essay, etc. by merely answering computer generated questions utilizing conversational technology. Questions for an autobiography may cover areas pertaining to the user's family, career, childhood, and other pertinent information which is typically found in a biographical account.

During execution of an “interview” software module, the user is asked a series of questions by the computer. Both the questions and answers may be in audio format comprising the user's electronic computing device emitting a computer generated voice from the device speaker, and the user responding by speaking into the device microphone. Additionally, or alternatively, the questions may be displayed in text on the user's device display and/or the user may respond to the questions by manually inputting text.

When the user responds to a computer question with a statement, the computer analyzes the words and phrases within the statement to identify keywords, central topics and themes, dates and events, etc. that the computer uses to classify and group information. The information is then used by the computer to determine if one or more follow-up questions or validations are needed to clarify the user's intent in their statement. This may comprise the computer paraphrasing and reflecting back for confirmation that the computer's interpretation of the user's statement is correct. Computer generated follow-up questions may also be used to gain additional information needed to properly classify the event(s) disclosed in the statement.

Once the “Interview Module” is complete, the computer compiles the information, which may also include other digital media, such as digital pictures, videos, text, etc., that the user provides by uploading to the computer and/or by providing via a network link (e.g. http://), and/or that is readily identified and accessible by the computer via the system network (e.g. Internet posting). The computer then maps out the user's life chronologically, as well as by event and topic, filters and analyzes the information, and subsequently and automatedly writes a textual draft document.

User can select the ‘content’ software element, whereby they can download any photos, additional texts, graphics, design, etc. It will also assist the user (via generated questions) with potential book title and other components found in a biographical book (i.e, chapters, forewords, acknowledgement page, dedication page, introduction page, preface, table of contents) It will also number the pages and subjects accordingly. Again, f/u questions may follow for confirmation. The computer records user's answers, writes and stores in the user's records.

Once the draft is complete, a “Editor and Publishing Module” will filter content, edit the draft for syntax, grammar/spelling checks etc., (more so for when the user uses the revisions module or manually inputs info). Thereafter this module, will collaborate all components and perform other functions to produce/write a final digital version of the Ebook-biobraphy. Additional info that this module will include is links or info listing companies who can produce a hard cover or soft cover book (if the user so wishes). The editor and publishing functionality of the various embodiments may be provided by computer systems and methods known in the art, and/or it may be co-located with and/or incorporated into the interviewing module. The publishing module will display on and save within a computer memory, as well as transmit via a network, the final digital version of the textual document, comprising for example, an autobiographical book, short story, essay, etc.

The system will have a ‘Revisions’ element whereby the user will have the ability to manually or automatedly (with f/u questions) revise accordingly by adding, changing, modifying, deleting etc., anything they would like in the draft, final version or even new copy at any time.

It is noted that while the various exemplified embodiments disclosed herein are primarily directed to the writing of autobiographical books, the present disclosure is applicable to other types of textual documents, such as essays, short stories, etc.; and, for a variety of narrative types, such as written accounts of historical events, applications for employment and/or education, etc.

Various embodiments of the presently disclosed subject matter may include or be embodied in the form of computer-implemented methods or processes and apparatuses or electronic computing devices for practicing those methods or processes; and, in the form of a computer program product having computer program code containing instructions embodied in non-transitory and/or tangible media, such as floppy diskettes, CD-ROMs, hard drives, USB (universal serial bus) drives, the Cloud, or any other machine readable storage medium, wherein, when the computer program code is loaded into and executed by a computer, the computer becomes an apparatus for practicing embodiments of the disclosed subject matter.

The various embodiments of the present disclosure in the form of computer program code, for example, is stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

The various embodiments of the present disclosure may also be in the form of a “computer system” comprising one or more computers—each computer further comprising a computer-readable medium embodying software or instruction to operate the computer or one or more of its components (e.g. processor(s)).

The computer system may include, by way of non-limiting examples: a distributed computer system for processing information via computer systems linked by a network; two or more computer systems connected together via a network for transmitting and/or receiving information and data between the computer systems; a computer system including two or more processors within a single computer; and, one or more apparatuses and/or one or more systems that may receive and process instructions and data, in accordance with one or more stored software programs, that may generate results.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The above and other features, aspects, and advantages of the present disclosure will become better understood with regard to the following description, appended claims, and accompanying drawings where:

FIG. 1 is an illustration of one embodiment of the computer system architecture.

FIG. 2 is a block diagram of various embodiments of a user's electronic computing device comprising a smartphone, tablet, laptop, etc.

FIG. 3 is a flowchart of computer steps during the “Interview” module.

FIG. 4 is a flowchart of computer steps in the system generating follow-up questions based on a user's answer.

FIG. 5 is a flowchart of computer steps during the “Publishing” module for organizing, classifying, editing, and publishing the final document.

FIG. 6 is a flowchart of computer steps during the “Revision” module.

FIG. 7 shows other applications for the system.

FIG. 8 shows some of the purposes of the system.

### DETAILED DESCRIPTION

The following description should not be used to limit the scope of the present disclosure. Other examples, features, aspects, embodiments, and advantages of the disclosure will become apparent to those skilled in the art from the following description, which includes by way of illustration, one of the various example embodiments. As will be realized, the disclosure is capable of other different and obvious aspects, all without departing from the inventive subject matter. Accordingly, the drawings and descriptions should be regarded as illustrative in nature and not restrictive. It should therefore be understood that the inventors contemplate a variety of embodiments that are not explicitly disclosed herein.

The various embodiments of the computer system may be implemented using hardware and software components that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk, the Cloud or any other device capable of storing electronic information. The memory may store instructions adapted to be executed by the processor to perform the techniques according to embodiments of the disclosed subject matter.

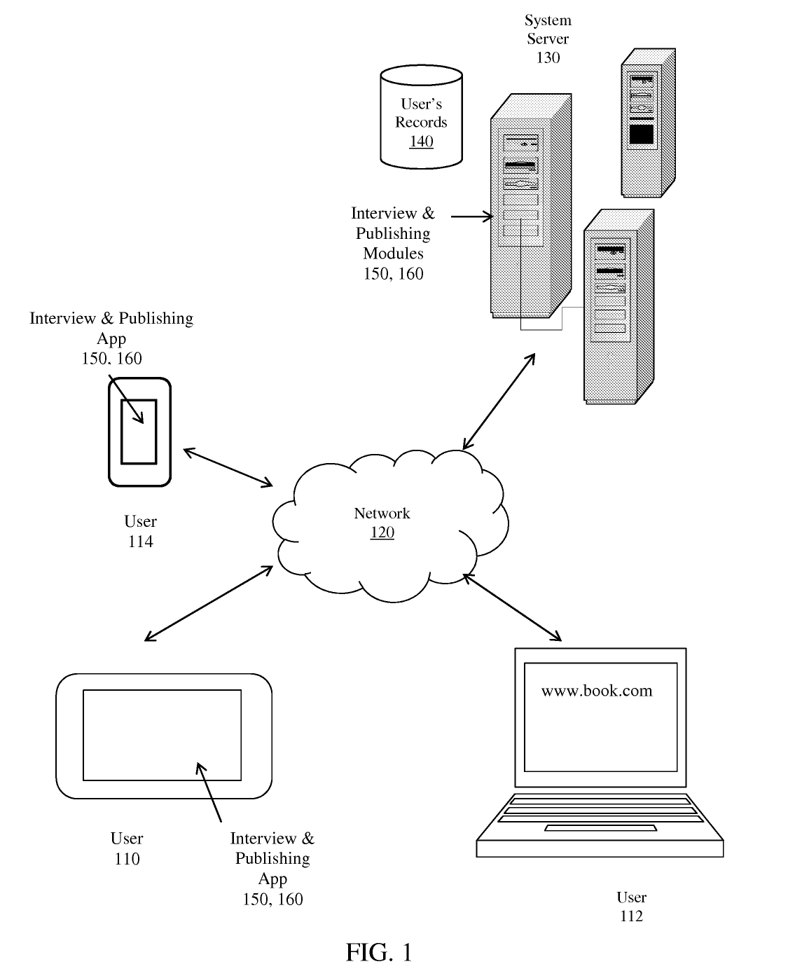

FIG. 1 illustrates an example embodiment of the computer system for various embodiments of the present disclosure comprising the following components: one or more user's electronic computing devices with network connectivity 110 (e.g. a tablet), 112 (e.g. a laptop), 114 (e.g. a smartphone); a system server 130 housing user's records, wherein the server 130 housing user's records within a database 140, and the user's devices 110, 112, and 114 communicate via a network 120. Various embodiments of the presently disclosed subject matter may include or be embodied in the form of computer-implemented methods or processes and apparatuses or electronic computing devices for practicing those methods or processes; and, in the form of a computer program product having computer program code containing instructions embodied in non-transitory and/or tangible media, such as floppy diskettes, CD-ROMs, hard drives, USB (universal serial bus) drives, the Cloud, or any other machine readable storage medium, wherein, when the computer program code is loaded into and executed by a computer, the computer becomes an apparatus for practicing embodiments of the disclosed subject matter.

The electronic computing devices 110, 112, and 114 may communicate with the server 130, or each other (e.g. peer-to-peer) to send and receive data and computer instruction via the network 120. The network 120 may be a wireless (cellular, satellite, microwave, infrared, radio, etc.) network, local network, wide-area network, the Internet, or any other suitable communication network or networks, and may be implemented on any suitable platform including wired and/or wireless networks.

In addition to Internet connectivity, the electronic computing devices 110, 114, may also communicate via a network 120 comprising radio wave transmission components dedicated to cellular telephone functions. The basic components shown provide the ability for the mobile computing device to perform radio-frequency communications, including telephonic communications. The radio components include a baseband-radio processor 204, an RF transceiver module 206, a radio flash memory 208, and an antenna. The radio processor 204 modulates data to be transmitted and demodulates data received in accordance with the protocols of the cellular telephone standard employed by the device 110, 114. For example, the radio processor 204 may be a CDMA baseband processor that modulates and demodulates data according to the CDMA standard. The processor 204 may perform other functions to control the operation of the radio portion of the user's device, such as determining and gathering information on the performance or characteristics of the cellular communication. The RF transceiver 206 amplifies and transmits the data modulated by the processor 204 through the antenna and also receives cellular communication data through the antenna for demodulation by the radio processor 204.

The various embodiments may thus comprise a client-server system architecture where some computing or processing steps occur on the user's device 110, 112, 114 and some on the system server 130. Additionally, or alternatively, all of the computing processing steps may occur on the user's client device 110, 112, 114 and/or on the system server 130.

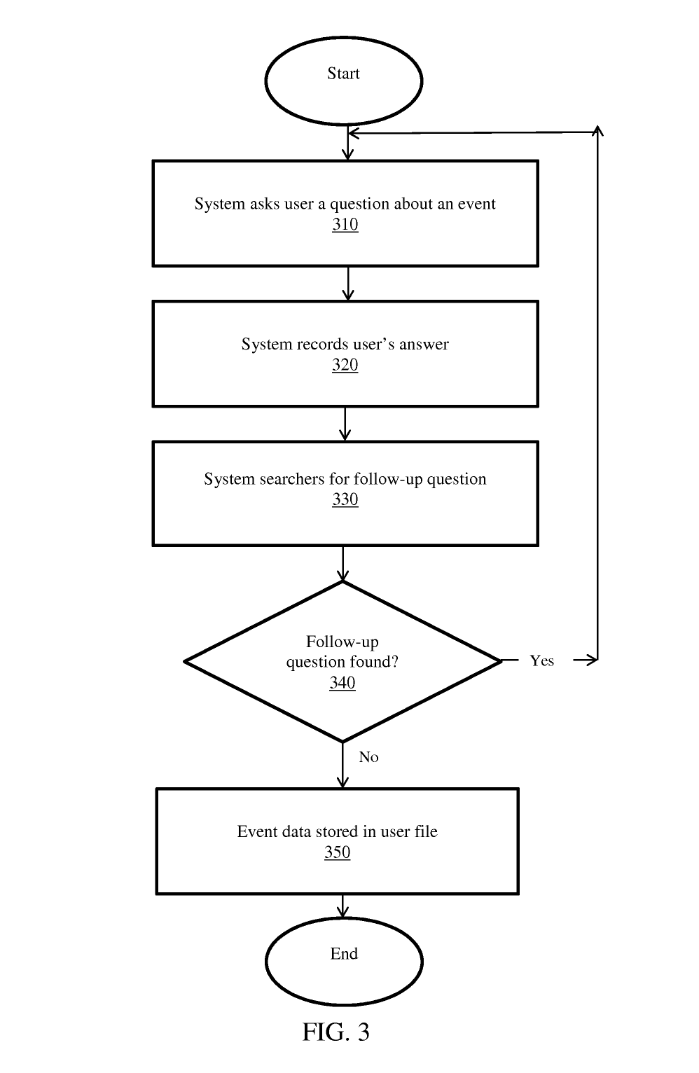

Computer code comprising instructions for the processor(s) to carry out the various embodiments, aspects, features, etc. of the present disclosure may reside in the memory of the user's device 110, 112, 114 and/or on the server 130. The code may be broken into separate routines, products, etc. to carry forth specific steps disclosed herein, such as in the flowcharts of FIGS. 3-5 for interviewing the user, and/or the code may be consolidated into one product for all aspects of the present disclosure, such as interviewing the user and automatedly compiling and publishing a digital book based on the user's answers.

For example, a publisher algorithm-module 160 may co-reside with, or be a part of, the “Interview Module” 150 installed on the user's electronic computing device 110, 112, 114, and/or on the system server 130 accessible via the network 120. The “Interview Module” 150 and/or the “Publisher Module” 160 may also be provided on a CD-ROM or other computer readable medium, such that it may be operated from the CD-ROM and/or installed on a user's electronic computing device for operation. In yet another embodiment, the algorithms 150 and 160 comprise a computer program and/or code that may be downloaded via the network 120 to a user's electronic computing device 110, 112, 114 for use thereon. Still other ways in which components of the computer system of the various embodiments may be provided, accessed, and/or operated will be apparent to those of ordinary skill in the art.

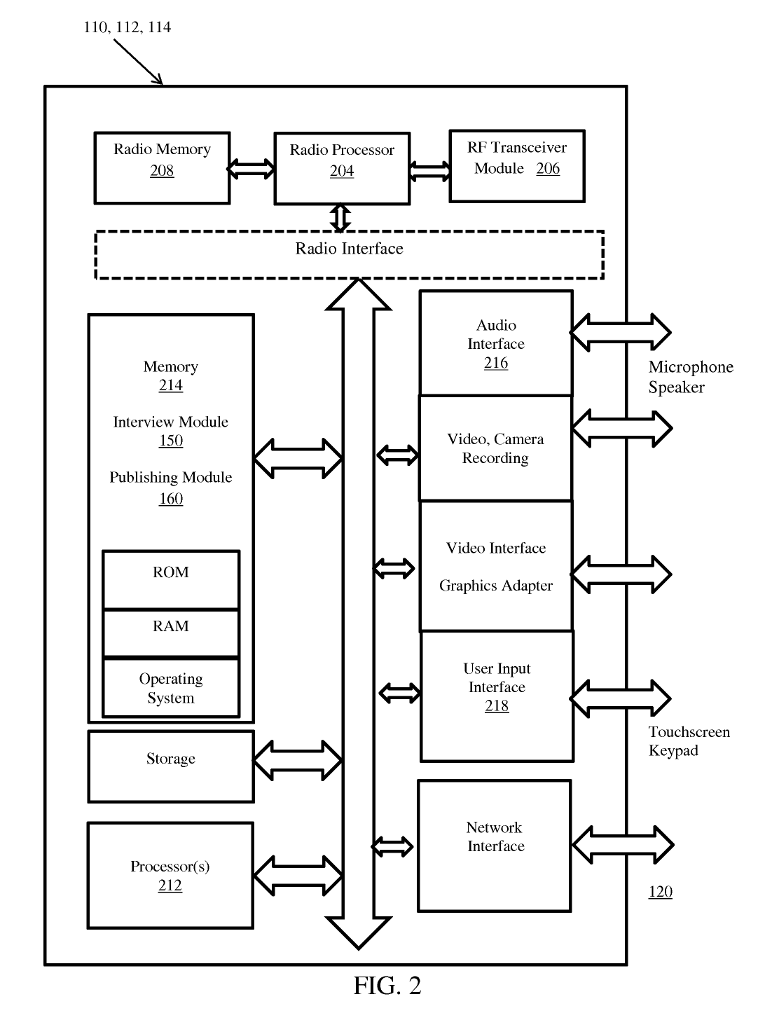

The present disclosure may further comprise an application installed on a user's electronic computing device, such as a smartphone 114 or tablet PC 110 or laptop computer 112, but may also include other computing devices such as a PDAs, ultra mobile PCs (UMPCs), laptop computers, desktop computers, servers. etc. It will be understood that the architecture illustrated in FIG. 2 is provided for example purposes only and does not limit the scope of the various implementations of the communication systems and methods.

Device 110, 112, and/or 114 comprises a processing circuit comprising a processor 212, and a memory 214 that stores machine instructions that when executed by the processor 212, cause the processor 212 to perform one or more of the operations and methods described herein. Processor 212 may optionally contain a cache memory unit for temporary local storage of instructions, data, or computer addresses. For example, using instructions retrieved from memory 214, the processor 212 may control the reception and manipulation of input and output data between components of the device 110.

In various embodiments, the processor 212 can be implemented as a single-chip, multiple chips and/or other electrical components including one or more integrated circuits and printed circuit boards.

The processor 212 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 214 encompasses one or more storage mediums and generally provides a place to store computer code (e.g., software and/or firmware) and data that are used by the device 110, 112, 114. It may comprise, for example, electronic, optical, magnetic, or any other storage or transmission device capable of providing the processor 212 with program instructions. Memory 214 may further include a floppy disk, CD-ROM, DVD, magnetic disk, memory chip, ASIC, FPGA, EEPROM, EPROM, flash memory, optical media, or any other suitable memory from which processor 212 can read instructions in computer programming languages.

Memory 214 may include various other tangible, non-transitory computer-readable media including Read-Only Memory (ROM) and/or Random-Access Memory (RAM). As is well known in the art, ROM acts to transfer data and instructions uni-directionally to the processor 212, and RAM is used typically to transfer data and instructions in a bi-directional manner. In the various embodiments disclosed herein, RAM includes computer program instructions that when executed by the processor 212 cause the processor 212 to execute the mobile App modules 150, and/or 160.

Processor 212 is generally coupled to a variety of interfaces such as graphics control (e.g. graphical processing unit (GPU)), video interface, audio interface 216, user input interface 218, and other interfaces, such as camera hardware and software components housed within and/or connected to devices 110, 112, 114 for recording and transmitting content. The audio interface 216 may convert sound into electrical signals using a microphone and for converting electrical signals into sound using a speaker. The input interface 218 may receive user input commands via touchscreen, a physical keyboard, virtual keyboard, etc.

Processor 212 is also coupled to a network interface that allows the processor to be coupled to another computer or telecommunications network (e.g., internet). More particularly, the network interface generally allows processor 212 to receive information from and to output information to the network in the course of performing various method steps described in the embodiments herein. In particular, the present embodiments disclosed herein may emit a computer generated voice to communicate with the user, such as asking the user follow-up questions, and the user may respond by speaking into the device's microphone, and/or typing on a physical or virtual keyboard, and/or by touchscreen selection.

Device 110, 112, 114 may further have installed within the device's memory computer instructions for executing the various embodiments of the disclosure comprising a native application, a web application, or a widget type application to carry out the methods of the embodiments disclosed herein (e.g. “Interviewing App” 150 and/or “Publishing App” 160, or an app incorporating both the functionality of 150, 160). In a preferred embodiment, a native application (e.g. computer program product) is installed on the device, wherein it is either pre-installed on the device or it is downloaded from the Internet via email and activated with a code generated by the system server. It may be written in a language to run on a variety of different types of devices; or it may be written in a device-specific computer programming language for a specific type of device.

In another embodiment, a web application resides on a remote server 130 accessed via the network 120. It performs basically all the same task as a native application, usually by downloading part of the application to the end user's device 110, 112, 114 for local processing each time it is used. The web application software is written as Web pages in HTML and CSS or other language serving the same purpose, with the interactive parts in JavaScript or other language. Or the web application can comprise a widget as a packaged/downloadable/installable web application; making it more like a traditional application than a web application; but like a web application uses HTML/CSS/JavaScript and access to the Internet. And/or device 110, 112, 114 may include a web browser running applications (e.g. Java applets or other like applications), comprising application programming interfaces (“APIs”) to other software applications running on remote servers that provide, for example, cloud based services and comment posting.

FIG. 3 is a flowchart depicting the actions taken by the system (e.g. remote server 130 or user's client electronic computing device 110). In step 310, the system begins a “conversation” with the user by asking them a series of personal questions, pertaining to a variety of areas of their life, such as their history, family, career, childhood, etc. The question may be emitted from the user's electronic computing device in the form of a computer generated voice and/or via written text displayed on the graphical user interface or screen. Methods of creating computer generated voices are well known in the art.

In step 320, the system records the user's response to the question, which may be in the form of a spoken response into the microphone of the computing device 110, 112, and/or manually input into the device 110, 112 via a touchscreen, keyboard, etc.

In step 330, the system searches for a follow-up question that relates to the original question asked in step 310, and/or to the content of the user's answer to the question in step 310. If a follow-up question is identified in step 340, then the system repeats steps 310-330. In addition to asking a follow-up question, the system in step 330 may paraphrase the user's answer and give the user the opportunity to indicate whether the system's interpretation of the user's answer is correct thereby emulating a conversation with the user as may be referred to as conversational technology.

Once the system determines that no follow-up and/or clarification question is needed, it will then store the user's answers in the computer memory of the user's electronic computing device 110, 112 and/or on the user's record on the remote system database.

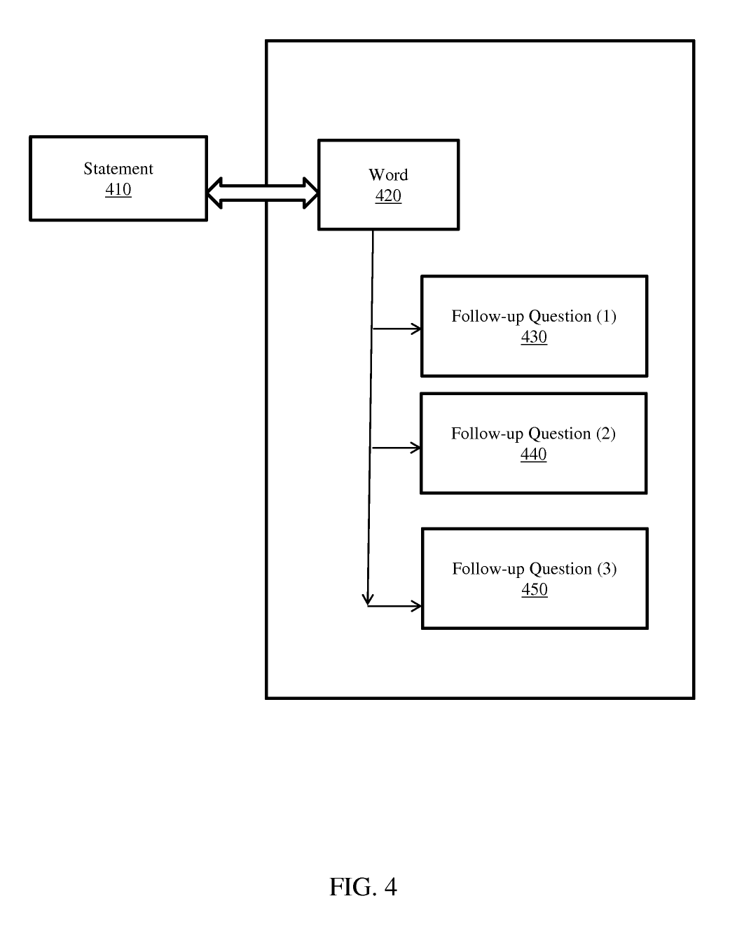

FIG. 4 is a flowchart of the computer system's steps in analyzing a user's response 410 to determine if a follow-up question is required. The system analyzes the user's statement or response to a system question in step 310 of FIG. 3 by, for example, identifying keywords 420 and classifying the response into categories, such as topics and themes. Based upon the keywords and classifications, the system determines what if any follow-up questions to ask the user or any necessary validations (see FIG. 4, 430-450). Again it is noted that the follow-up questions, such as 430-450, may comprise the system paraphrasing the user's response in FIG. 3, step 320 to give the user the opportunity to elaborate on and/or correct their response.

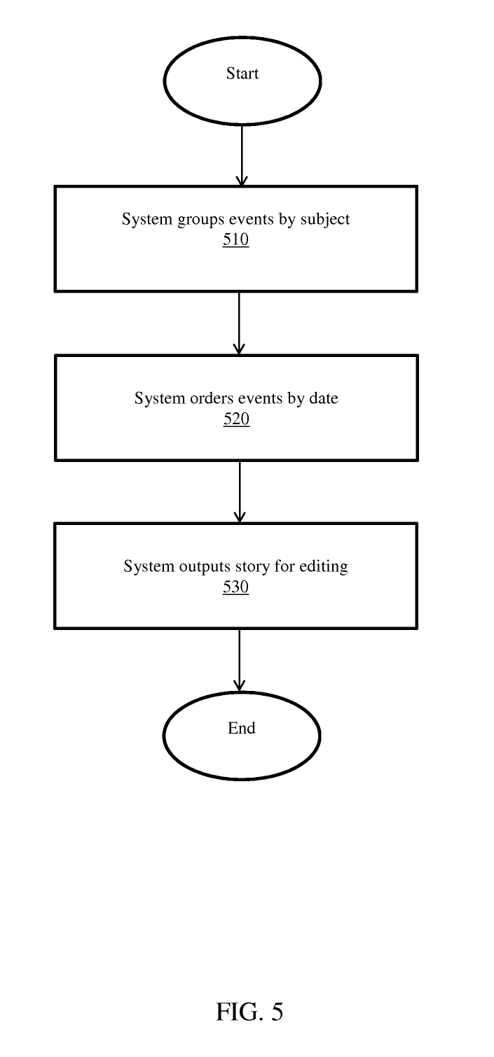

FIG. 5 is a flowchart of the computer system's steps in further analyzing and organizing the user's responses into data that is imported into a word processing document to publish the user's autobiography. The system will organize the user's responses by subject matter, as per step 510, such as events in a user's career that spanned multiple decades. The system will then order the events within each subject chronologically (step 520).

And the system will then compile and output the draft autobiography text for editing, such as in the format for a short story or book (step 530). Editing may be accomplished by manual and/or automated means. For example, the user my select to input manual amendments or personalization to the text (e.g. inserts, deletions, re-wording, correcting grammar, etc.) while reading the draft autobiography. The user may additionally, or alternatively, rely upon automated editors, such as those known in the art of document generation software (e.g. Microsoft® Word) to find and alter the language or grammar of the draft autobiography.

The editorial process of step 530 may further comprise: allowing the user to import audio and digital pictures relating to their responses. The system will then assign the media to appropriate places within the user's narrative. Step 530 may also comprise mapping, filtering and analyzing the user data for assigning it into chapters and for recommending titles.

Once it has been determined that the amendments are complete, then the draft may be provided to the user as a textual document, such as a digital book, short story, memo (e.g. job application) viewable on a user's electronic computing device. Optionally, the user may thereafter choose to publish the document as 5 in hard or paperback copy in any known manner such as, by way of non-limiting example, a third party publishing software well known to the ordinary artisan, and/or the Publishing Modules 160 that are co-located with or incorporated into the Interviewing Modules 150 on the system server 130 or on the user's device 110, 112, 114.

Operation

The user 110 begins the system.

During execution of the ‘interview’ software element (or field) the user is asked a series of questions by the computer generated voice: life story questions such as family, history, beliefs, experiences, career, achievements, ones journey in life, etc., and any other questions as it relates to biographical or story subject matter.

When the user responds via their computer microphone or apparatus to the computer generated questions, the computer will record the user's answers. Thereafter it will go to work analyzing the words/phrases within the statements to capture and identify keywords, central topics, subjects, themes, dates and events etc. and then will compile, write, and store in memory (or apparatus memory) and divide into chapters. The computer then uses this information to map out or classify and then group information accordingly. The computer searches for ‘follow up questions’ if needed, or may paraphrase and reflect back statements in order to confirm/clarify user's information. If more information is needed then follow-up questions will continue: the interview and follow up question element will continue (conversational tech) as long or as short as the user wishes or until complete.

User can select the ‘content’ software element, whereby they can download any photos, additional texts, graphics, design, etc. It will also assist the user (via generated questions) with potential book title and other components found in a biographical book (i.e, chapters, forewords, acknowledgement page, dedication page, introduction page, preface, table of contents) It will also number the pages and subjects accordingly. Again, f/u questions may follow for confirmation. The computer records user's answers, writes and stores in the user's records 140.

Once the draft is complete, a User can select the ‘editor and publishing’ software element, whereby once the draft is complete this module will filter content, edit the draft for syntax, grammar checks etc. Thereafter will collaborate all components and perform other functions to produce/write a final digital version of the eBook/document/text=autobiography. Again records, writes and stores in memory). Additional info: Links or info will be provided listing companies who can produce a hard cover or soft cover book printing (if the user wishes). Once the draft is complete, a “Editor and Publishing Module” edits the draft for syntax, grammar, etc., adds a title, and headings for chapters and paragraphs and figures, and performs other functions necessary to produce a final digital textual version. (more so for when the user uses the revisions module or manually inputs info). Thereafter this module, will collaborate all components and perform other functions to produce/write a final digital version of the Ebook-biobraphy. Additional info that this module will include is links or info listing companies who can produce a hard cover or soft cover book (if the user so wishes).

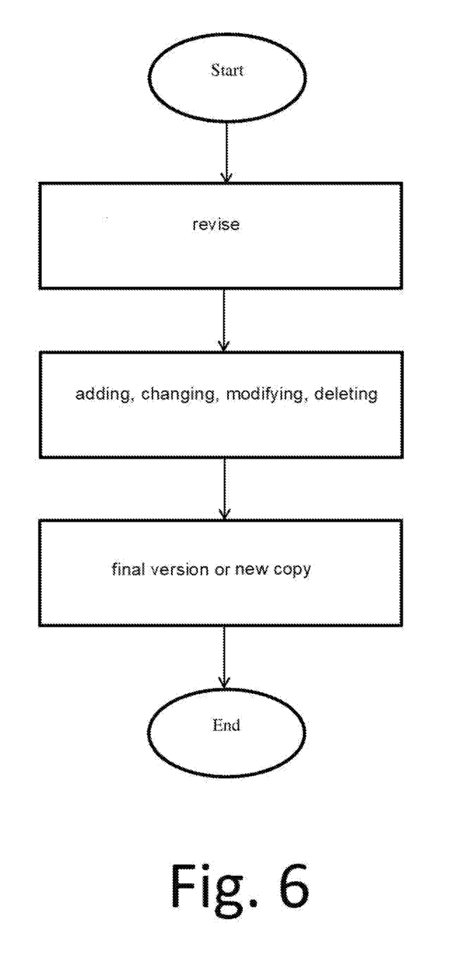

The system will have a ‘Revisions’ element, as shown in FIG. 6, whereby the user will have the ability to manually or automatedly (with f/u questions) revise accordingly by adding, changing, modifying, deleting etc., anything they would like in the draft, final version or even new copy at any time.

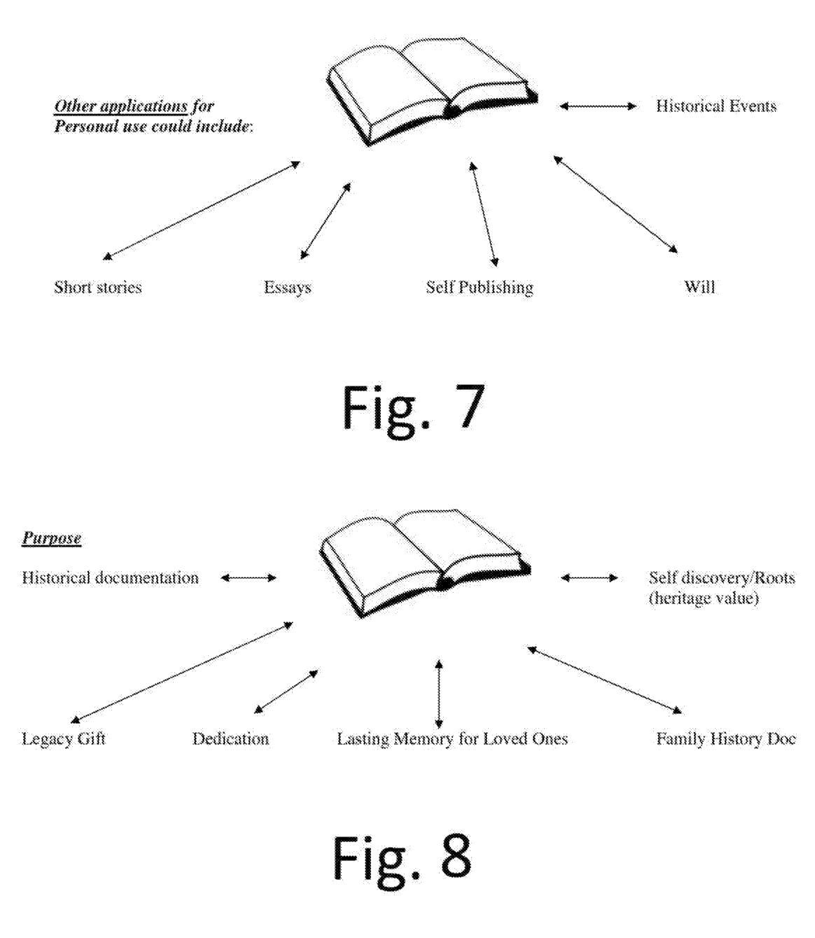

The other applications for the system, as shown in FIG. 7, include using it for short stories, essays, self publishing, wills and historical event all viewable and savable on the user's devices 110, 112, 114.

Some of the purposes of the system as shown in FIG. 8 include historical documentation, legacy gifts, dedication, lasting memory for loved ones, family history documentations and self-discovery and roots.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A computerized method for automatedly generating a user document that details a user autobiography, comprising:
a. generating by a computer one or more biographical questions for production on a user electronic computing device, wherein the biographical questions are to elicit information about: a user's family, personal stories, and non-work related information;
b. receiving by the computer the an user inputted user response to the question(s);
c. analyzing the user response by the computer whether or not follow-up questions to the user response are required; and, if so, then repeating steps (a)-(c), whereby the follow-up questions include a paraphrasing of the user response to allow the user to elaborate and correct the user response;
d. if not, then storing the analyzed response in a computer memory;
e. revising the user response; and
f. editing the response if desired.

2. The method of claim 1, wherein analyzing the user response comprises classifying and storing in the memory the user response as an event associated with a date or time frame.

3. The method of claim 2 further comprising preparing the user document for publication, comprising the steps of:
a. organizing by the computer the events into at least one of subjects and events by date; and
b. compiling a the document into sections by at least one of subject and chronological order based on the date.

4. The method of claim 3 further comprising editing and providing the document about the user response into a digital format accessible over a network.

5. The method of claim 1, wherein the document is one or more of a digital book, article, resume, short story, biography, and/or autobiography.

6. The method of claim 3, further comprising a user uploading digital media to the computer system comprising digital photographs, video, and/or audio content.

7. The method of claim 6, wherein organizing by the computer comprises incorporating the digital media into the user document.

8. The method of claim 3, wherein compiling the document comprises the computer directing and assisting a user in selecting at least one of titles, chapters, contents and a dedication page for the document, and for one or more headings within the document.

9. A non-transitory computer readable storage medium, including a computer system, storing thereon computer-readable instructions for automatedly generating a user's autobiographical book, the computer readable storage medium comprising:
a. instructions for generating by a computer one or more biographical questions for production on a user electronic computing device wherein the biographical questions are to elicit information about: a user's family, personal stories, and non-work related information;
b. instructions for receiving by the computer an inputted user response to the question(s), wherein the user response input may be via audio and textual;
c. instructions for analyzing the user response by the computer whether or not follow-up questions to the user response are required; and, if so, then repeating steps (a)-(c), whereby the follow-up questions include a paraphrasing of the user response to allow the user to elaborate and correct the user response; and, if not, then storing the analyzed response in a computer memory;
d. wherein analyzing the user response comprises instructions for classifying and storing, in the memory, the user response as an event associated with a date or time frame; and
e. revising the autobiographical book.

10. The non-transitory computer readable storage medium of claim 9 further comprising preparing a document for publication, comprising:
a. instructions for organizing by the computer the events into at least one of subjects and events by date; and
b. instructions for compiling the document into sections by at least one of subject and by chronological order based on the date.

11. The non-transitory computer readable storage medium of claim 10, further comprising instructions for editing and providing the documents into a digital format accessible over a network.

12. The non-transitory computer readable storage medium of claim 10, further comprising instructions for the computer system to upload and store in the memory digital media comprising digital photographs, video, and/or audio content.

13. The non-transitory computer readable storage medium of claim 12, wherein organizing by the computer comprises incorporating the digital media into the document.

14. The non-transitory computer readable storage medium of claim 10, wherein compiling the document comprises the computer directing and assisting the a user in selecting titles for the document, and for one or more headings within the document.

15. An apparatus adapted for automatedly generating a user's autobiographical book, comprising:
a) a graphical user interface display;
b) at least one processor;
c) a network interface;
d) a microphone and speaker;
e) at least one computer memory;
f) a computer readable medium operatively coupled to the user interface, the computer readable medium encoded with computer executable components which, when executed:
(i) generate by a computer one or more biographical questions for production on the apparatus wherein the biographical questions are to elicit information about:
a user's family, personal stories, and non-work related information;
(ii) receive by the computer the user inputted user's response to the question(s), wherein the user's response input may be provided via audio and textual;
(iii) analyze, by the computer, the user's response, whether or not follow-up questions to the user's response are required; and, if so, then repeating steps (a)-(c), whereby the follow-up questions include a paraphrasing of the user response to allow the user to elaborate and correct the user response; and, if not, then storing the analyzed response in a computer memory; and
(iv) wherein the analyzing of the user response comprises classifying and storing in the memory the user response as an event associated with a date or time frame; and
g) wherein the computer readable medium is stored in the apparatus memory or accessible via utilizing a network; and
h) revising the autobiographical book.

16. The apparatus of claim 15, further comprising preparing the document for publication, by the computer readable medium being encoded with computer executable components which, when executed:
a. organize by the computer the events into at least one of subjects and events by date; and
b. compile the document into sections by at least one of subject and chronological order based on the date; and
c. edit and provide the document to about the user responses into a digital format accessible over a network.

17. The apparatus of claim 16, further comprising the computer readable medium being encoded with computer executable components which, when executed cause the apparatus to upload and store in the memory digital media comprising digital photographs, video, and/or audio content, and wherein organizing by the computer comprises incorporating the digital media into the document.

18. The apparatus of claim 16, wherein compiling the document comprises the computer directing and assisting the a user in selecting titles for the document, and for one or more headings within the document.

19. The apparatus of claim 15, further comprising a computer system in communication with one or more apparatuses via a network, wherein the system may store in a memory one or more of the user responses, the document, and all or part of the computer readable medium accessible by the apparatus via the network.
